(19) United States
(12) Patent Application Publication
(10) Pub. No.: US 2020/0198395 A1
(43) Pub. Date: Jun. 25, 2020

(54) WHEEL HUB TRANSMISSION UNIT FOR A WHEEL HUB OF A VEHICLE, WHEEL HUB, AND AN AUXILIARY DRIVEN VEHICLE

(71) Applicant: lnnotorq GmbH, Martinsried (DE)

(72) Inventor: Theodor Piele, Gauting (DE)

(21) Appl. No.: 16/805,758

(22) Filed: Feb. 29, 2020

Related U.S. Application Data
(63) Continuation of application No. PCT/EP2018/066773, filed on Jun. 22, 2018.

(30) Foreign Application Priority Data
Aug. 29, 2017 (EP) 17 188 394.5

(51) Int. Cl. B60B 27/00; B62M 6/50; B60B 27/02; B60B 27/04

(52) U.S. Cl. CPC B60B 27/0068; B62M 6/50; B60B 2200/47; B60B 27/047; B60Y 2400/307; B60B 27/023

(57) ABSTRACT

A wheel hub transmission unit for a wheel hub defining an axis of rotation includes a pinion hub carrier arranged concentrically with respect to the axis of rotation and onto which a pinion is mounted torsionally rigid to drive the wheel hub, a hub body arranged axially next to the pinion hub carrier and having an interior space, a transmission sleeve arranged concentrically inside the interior space and including a magnetically coded material that forms a measuring portion, a drive coupling via which the pinion hub carrier and the transmission sleeve are coupled, and an output coupling via which the transmission sleeve is coupled to the hub body such that the torque is detectable in the interior space by the measuring portion of the transmission sleeve by the magnetic properties of the magnetically coded material, wherein the magnetic properties change under the influence of the torque.

### CROSS REFERENCE TO RELATED APPLICATIONS

This application is a continuation application of international patent application PCT/EP2018/066773, filed Jun. 22, 2018, designating the United States and claiming priority to European patent application 17188394.5, filed Aug. 29, 2017, and the entire content of both applications is incorporated herein by reference.

### TECHNICAL FIELD

The disclosure relates to a wheel hub transmission unit for a wheel hub of a vehicle, to the wheel hub with the wheel hub transmission unit, and to an auxiliary driven vehicle with the wheel hub.

### BACKGROUND

Due to an increasingly improving infrastructure for cyclists in cities and rural areas, a growing environmental awareness and/or a growing health awareness, the number of cyclists is continuously growing. In particular a bicycle with an electric auxiliary engine, an electric bicycle, is interesting to realize desired time advantages or to achieve sport goals. In the electric bicycle, an electric engine generates a torque that moves the bicycle either in addition to a torque generated by muscle power or alone. The electric bicycle includes besides the conventional drive parts, such as a pedal crank, a chain ring that is mounted on the pedal crank, a pinion that is mounted in drive direction torsionally rigid on the rear wheel, and a chain that transmits the torque from the chain ring to the pinion, additionally the electric engine, accumulator cells that supply the electric engine with energy, and a sensor system for determining the required torque that is provided by the electric engine.

It is known to provide a torque measuring device on the rear wheel for the determination of the required additional torque. The torque measuring device includes a measuring sleeve that is made of non-magnetic material and that is provided with a corresponding magnetization pattern that changes under the influence of the torque on the measuring sleeve. This change can be detected by an electrically operated coil pair, whereby a conclusion can be made about the required torque. For a precise measurement, the coil pair is to be arranged immediately adjacent to the measuring sleeve, whereby positioning conflicts with other parts of the hub are caused, such as for example a carrier for the pinion, the pinion hub carrier. Additionally, a longest possible measuring track is to be provided for a sufficiently precise measurement of the torque. This is usually not possible without restrictions due to required bearings for radial and/or axial support of parts. Furthermore, the measurement track is to be protected from impurities for a long-term high detection precision.

### SUMMARY

It is an object of the present disclosure to provide a wheel hub transmission unit for a wheel hub of a vehicle, a wheel hub with the wheel hub transmission unit and an auxiliary driven vehicle with the wheel hub, wherein the wheel hub transmission unit is of simple, compact and robust construction and a torque is precisely detectable.

The object is achieved by a wheel hub transmission unit for a wheel hub of a vehicle, a wheel hub with the wheel hub transmission unit, and an auxiliary driven vehicle that includes the wheel hub as described herein.

The wheel hub transmission unit is for a wheel hub of a vehicle and includes an axis of rotation, a pinion hub carrier that is arranged concentrically with respect to the axis of rotation and onto which at least one pinion can be mounted torsionally rigid in order to drive the wheel hub, a hub body that is arranged axially next to the pinion hub carrier and that includes an interior space that is arranged concentrically with respect to the axis of rotation, a transmission sleeve that is arranged concentrically with respect to the axis of rotation inside of the interior space and that includes a magnetically coded material that forms a measuring portion of the transmission sleeve and a drive coupling via which the pinion hub carrier with its longitudinal end facing towards the hub body and the transmission sleeve with its longitudinal end facing towards the pinion hub carrier are coupled, as well as an output coupling via which the transmission sleeve with its other longitudinal end is coupled to the hub body, such that a torque is transmittable from the pinion hub carrier to the hub body via the drive coupling, the output coupling and the transmission sleeve, such that the torque is detectable in the interior space by the measuring portion of the transmission sleeve by the magnetic properties of the magnetically coded material, wherein the magnetic properties change under the influence of the torque.

The interior space includes a larger axial extension in comparison to the pinion hub carrier. If the transmission sleeve is arranged inside the interior space, it is possible that the transmission sleeve can include a larger axial extension in comparison to conventional wheel hub transmission units, where, for example, the transmission sleeve is arranged inside the pinion hub carrier. With the inventive transmission sleeve with the large axial extension, the torque is advantageously precisely detectable.

Furthermore, the hub body forms a housing for the transmission sleeve as a result of the transmission sleeve being arranged inside the interior space. The transmission sleeve can therefore advantageously be protected against external influences such as dirt particles. The housing forms radially outwards an insurmountable barrier for dirt particles. Besides, very simple sealing elements can be arranged at the respective longitudinal ends of the hub body to protect the transmission sleeve from dirt particles that axially penetrate. If, for example, the pinion hub carrier is exchanged, the interior space in which the transmission sleeve is arranged is also protected against external influences during the exchange. With a conventional transmission sleeve that is arranged radially inside the pinion hub carrier the transmission sleeve can, for example, hardly be protected against external influences during the exchange. As a result of the transmission sleeve being advantageously protected against external influences in all operating phases of the wheel hub transmission unit, the transmission sleeve is robust and has additionally a long lifespan.

The transmission sleeve is torsionally rigid connected with the hub body, which is why the transmission sleeve rotates at the same revolution speed as the hub body when the wheel hub is in operation. Knowledge of the revolution speed is indispensable for capturing operating states such as, for example, a velocity. As a result of, for example, the transmission sleeve being connected to the hub body not torsionally rigid via a freewheel, the revolution speed is conventionally detected at a different position than the torque. Due to the construction according to the disclosure, the transmission sleeve is torsionally rigid connected to the hub body such that the measuring unit can detect both the torque and the revolution speed and output them optionally via only one transmission line. Thus, fewer and/or shorter lines are required and additionally the revolution speed measurement is also protected against external influences, because it can also be arranged within the interior space. Because of that, the wheel hub transmission unit is of compact and simple construction.

As a result of the transmission sleeve being arranged axially next to the pinion hub carrier, the installation space radially inside of the pinion hub carrier is free of the transmission sleeve and the measuring unit. If, for example, a pinion hub carrier with a smaller diameter is installed, this can be realised with relatively minor constructional changes. The transmission sleeve and the measuring unit are hardly affected by the constructional changes. If the transmission sleeve and the measuring unit would be arranged as conventionally usual, for example, inside the pinion hub carrier, the entire wheel hub transmission unit would have to be reconstructed. This makes the wheel hub transmission unit additionally advantageously of simple construction.

According to an aspect of the disclosure, for coupling of the hub body with the transmission sleeve, the output coupling is set at a portion of the longitudinal end of the hub body, wherein the longitudinal end of the hub body faces away from the pinion hub carrier, wherein the portion of the longitudinal end of the hub body is limited in axial direction towards the pinion hub carrier by a virtual plane that stands perpendicular to the measuring portion and that borders the measuring portion at its longitudinal end that faces away from the pinion hub carrier.

The measuring portion is formed by the magnetically coded material and extends cylindrically with respect to the axis of rotation and concentrically with respect to the axis of rotation. The output coupling is arranged in the portion of the hub body that is axially further away from the pinion hub carrier than the measuring portion. The drive coupling is thereby advantageously set to the hub body at the portion that is axially further away from the pinion hub carrier than the measuring portion, which is why the wheel hub transmission unit is of robust and simple construction.

For example, an output coupling can be installed that includes a relatively long axial extension, wherein the one longitudinal end of the output coupling is arranged at the portion of the longitudinal end of the hub body and the other longitudinal end of the output coupling is arranged at the transmission sleeve. It is thus possible to install different output couplings with different axial extensions.

According to another aspect of the disclosure, for coupling of the hub body with the transmission sleeve, the output coupling is set at the portion of a longitudinal end of the transmission sleeve, wherein the longitudinal end of the transmission sleeve faces away from the pinion hub carrier, wherein the portion of the longitudinal end of the transmission sleeve extends in axial direction towards the pinion hub carrier to the measuring portion.

As a result of the portion of the longitudinal end of the transmission sleeve being limited in axial direction towards the pinion hub carrier by the measuring portion, the output coupling can only be arranged on the transmission sleeve at the portion that is axially further away from the pinion hub carrier than the entire measuring portion. The wheel hub transmission unit thereby includes a particular simple axial construction.

According to an aspect of the disclosure, the transmission sleeve bridges a distance that extends at least from a first link plane that is intended for spokes to a second link plane that is intended for spokes, wherein the first link plane is arranged at one of the longitudinal ends of the hub body and wherein the second link plane is arranged at the other of the longitudinal ends of the hub body.

The link plane that is intended for spokes is the plane that is arranged perpendicular with respect to the axial extension of the hub body and that intersects several link positions for the spokes in the circumferential direction of the hub body. The hub body includes usually two of these planes at respectively one of the longitudinal ends. However, it is also conceivable that the hub body includes several such planes at at least one of the longitudinal ends. This occurs in particular when the spokes are mounted at least partially side by side at one of the longitudinal ends of the hub body. The link positions for spokes are, for example, openings or bores on which the spokes are attachable to the hub body.

If one of the longitudinal ends of the hub body includes several of these link planes, the transmission sleeve typically bridges the distance from a link plane arranged centrally between the link planes at the one longitudinal end of the hub body to a second link plane arranged centrally between the link planes at the other longitudinal end of the of the hub body. Another distance, for example, between the two outermost or innermost planes can also be bridged.

As a result of the transmission sleeve bridging these distances, the transmission sleeve includes a particular large axial extension, whereby also the axial extension of the measuring portion is advantageously formed large. As a result of the axial extension of the measuring portion being advantageously formed large, it is possible to improve the detection precision of the wheel hub transmission unit.

According to yet another aspect of the disclosure, the transmission sleeve is configured such that the axial component of the flow of force is in the same direction along the whole transmission sleeve. The flow of force denotes a path of a force and/or of a torque in a part from a point of attack, a point of introduction, to a point at which the force and/or the torque are absorbed by a reaction force and/or a reaction torque. The axial component of the flow of force denotes the component that acts in orientation with respect to the axis of rotation. For example, the sign of the axial component of the flow of force is a plus along the entire transmission sleeve. It does not correspond to a sign change if the axial component is zero in some portions.

As a result of the axial component of the flow of force remaining unchanged along the entire transmission sleeve, the axial orientation of the force flow along the entire transmission sleeve does not change. However, it is for example possible, that the radial orientation of the flow of force changes along the transmission sleeve. Because of that, the transmission sleeve includes an elongated shape in only one direction. This can be, for example, a cylindrical shape, a conical shape or a cantilever shape, but meander-shaped shapes and the like would be excluded. As a result of the axial direction of the flow of force not changing, the torque detection is not affected by directional changes and the torque can be detected particularly advantageously. Additionally, the transmission sleeve is of a simple shape.

According to a further aspect of the disclosure, the measuring portion is arranged in a portion of the interior space, wherein the portion of the interior space is limited in axial direction by two virtual link planes, wherein the first of these link planes intersects the link positions that are intended for spokes at the one longitudinal end of the hub body, and wherein the second of these link planes intersects the link positions that are intended for spokes at the other longitudinal end of the hub body. As a result of the measuring portion being arranged within these two virtual link planes, the measuring portion includes an especially large axial extension, whereby the torque can be particularly precisely detected. Additionally, the measuring portion is simply protected from external influences, for example dirt particles, since it is arranged axially relatively centrally within the interior space.

According to yet another aspect of the disclosure, the pinion hub carrier and the transmission sleeve are arranged at a distance from each other and wherein the drive coupling bridges this distance. The distance between the pinion hub carrier and the transmission sleeve can be an axial distance or an axial distance and a radial distance, whereby the drive coupling bridges the radial distance and/or the axial distance.

According to an aspect of the disclosure, the drive coupling is a freewheel. The freewheel is a clutch that acts in a locking manner only in one of the possible directions of rotation. If the revolution speed of the transmission sleeve exceeds the revolution speed of the pinion hub carrier, a connection between the two parts is released automatically, whereby the transmission sleeve continues to rotate freely even if the pinion hub carrier rotates more slowly or even not at all.

According to another aspect of the disclosure, the drive coupling includes a first freewheel part that is connected torsionally rigid with the pinion hub carrier, wherein the drive coupling includes a second freewheel part that is connected torsionally rigid with the transmission sleeve, wherein the first freewheel part is arranged axially next to the second freewheel part. As a result of the first freewheel part being connected torsionally rigid to the pinion hub carrier and the second freewheel part being connected torsionally rigid to the transmission sleeve, the automatically releasing connection is relatively easy realizable by the freewheel parts.

According to an aspect of the disclosure, the first freewheel part and the second freewheel part of the wheel hub transmission unit can be axially displaced. As a result of the first freewheel part being able to be axially displaced in particular relative to the pinion hub carrier and the second freewheel being able to be axially displaced in particular relative to the transmission sleeve, the automatically releasing connection can be established by the axial relative displacement of the freewheel parts with respect to one another.

According to yet another aspect of the disclosure, the first freewheel part and the second freewheel part are configured to interact such that the substantially whole torque is transmittable from the pinion hub carrier to the transmission sleeve only in one direction of rotation of the pinion hub carrier. The freewheel parts can be for example provided with at least one tooth that includes a very steep flank and a very flat flank. If the first freewheel part rotates in the one of the directions of rotation a self-locking form fit is formed between the two parts by the interlocking teeth, whereby the torque can be transmitted. If the first freewheel part rotates in the other direction of rotation, no self-locking form fit can form between the two parts, as the teeth slide past each other, whereby no torque can be transmitted. A spring can, for example, thereby press the freewheel parts into each other again and again. Other exemplary embodiments such as, for example, by several teeth, balls or other wedge elements are also conceivable.

According to an aspect of the disclosure, the transmission sleeve is cantilever mounted. As a result of the transmission sleeve being cantilever mounted, the measuring unit can be positioned relatively freely and its cabling is simplified.

According to a further aspect of the disclosure, the wheel hub includes the wheel hub transmission unit and at least one of the pinions that is mounted torsionally rigid on the pinion hub carrier, wherein for transmitting of the torque in only one direction of rotation from the pinion to the hub body, the hub body is coupled torsionally rigid with the pinion via the drive coupling. The pinion can be form fit connected to the pinion hub carrier, for example by a splined shaft connection. For example, several pinion can also be arranged on the pinion hub carrier.

According to another aspect of the disclosure, an auxiliary driven vehicle includes the wheel hub, a drive assembly with a control device for the driving of the wheel hub in measured quantities, and the measuring unit for tapping off the measuring portion of the transmission sleeve, wherein the measuring unit is accommodated in the interior space and the control device can be controlled by the measuring unit in such a way that the drive torque of the drive assembly is adapted to the torque that is transmitted by the wheel hub transmission unit. The control device controls the drive torque of the drive assembly due to the detected torque and/or the detected torque revolution speed. The drive assembly can be arranged, for example, on the hub of the rear wheel of the vehicle, on the hub of the front wheel or on the pedal crank.

According to yet another aspect of the disclosure, the auxiliary driven vehicle is an electric bicycle. An electric bicycle can also be, for example, a pedelec. The pedelec is an exemplary embodiment of an electric bicycle in which the electric engine provides torque when simultaneously a driver presses the pedals.

For example, the pinion hub carrier is made of an aluminium alloy and the transmission sleeve is made of a high-strength non-magnetic steel.

### BRIEF DESCRIPTION OF THE DRAWINGS

The disclosure will now be described with reference to the drawings wherein:

FIG. 1 shows a perspective illustration of a wheel hub according to an exemplary embodiment of the disclosure, and

FIG. 2 shows an illustration of a longitudinal section of the wheel hub shown in FIG. 1.

### DESCRIPTION OF EXEMPLARY EMBODIMENTS

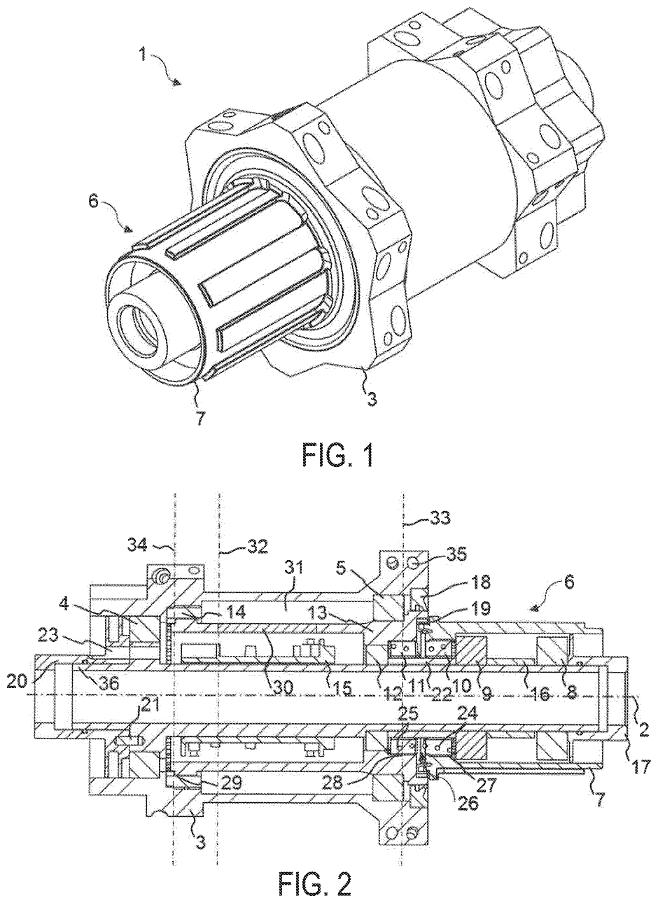

As shown FIGS. 1 and 2, a wheel hub 1 includes an axis of rotation 2, a wheel hub transmission unit 6, a wheel axle 36, and a hub body 3. The hub body 3 and the wheel axle 36 are arranged concentrically with respect to the axis of rotation 2. A first wheel hub bearing 4 and a transmission sleeve bearing 12 are arranged on the wheel axle 36, wherein the first wheel hub bearing 4 and the transmission sleeve bearing 12 support together with a second wheel hub bearing 5 the hub body 3.

The wheel hub transmission unit 6 includes a pinion hub carrier 7, a drive coupling 26, an output coupling 14, and a transmission sleeve 13 that is arranged within an interior space 31 formed by the hub body 3. The transmission sleeve 13 is supported in a cantilever manner by the transmission sleeve bearing 12 and the second wheel hub bearing 5. The transmission sleeve 13 is coupled with the hub body 3 torsionally rigid via the output coupling 14. This coupling can be made, for example, by a form fit connection 29. The transmission sleeve 13 is additionally coupled with the pinion hub carrier 7 torsionally rigid in at least one direction of rotation by the drive coupling 26. For this purpose, the drive coupling 26 includes a first freewheel part 10 and a second freewheel part 11. The first freewheel part 10 is coupled to the pinion hub carrier 7 torsionally rigid and axially displaceable via a first form fit connection 27 and the second freewheel part 11 is coupled to the transmission sleeve 13 torsionally rigid and axially displaceable via a second form fit connection 28. In addition, the drive coupling 26 includes a first spring part 24 and a second spring part 25. These two spring parts 24 and 25 are arranged on the drive coupling 26 such that they press the first freewheel part 10 and the second freewheel part 11 against each other. In the exemplary embodiment, the freewheel parts 10 and 11 include several teeth that include a very steep and a very flat flank. Due to the arrangement of the flanks, the teeth wedge only in one direction of rotation, in the other direction of rotation they slide past each other. The freewheel parts 10 and 11 are formed, for example, as a ring and include a saw tooth profile at one longitudinal end.

A first pinion carrier bearing 8 and a second pinion carrier bearing 9 are additionally arranged on the wheel axle 36. The pinion hub carrier 7 is axially and radially supported by these bearings 8 and 9. The required distance between the first pinion carrier bearing 8 and the second pinion carrier bearing 9 can be maintained by a first distance sleeve 16. In addition, an axial position of the bearings 8 and 9 can be adjusted via a first axle part 17. The required distance between the second pinion carrier bearing 9 and the transmission sleeve bearing 12 can be adjusted with a second distance sleeve 22. The wheel axle 36 includes an additional axle part 20 at its opposite end, wherein the axial position of the first wheel hub bearing can be adjusted by the axle part 20, in addition, the axle part 20 includes a through opening 23. A centering pin 21 is provided for centering the axle part 20 with the wheel axle 36. For example, cables can be routed through the through opening 23 into the interior space 31. A cabling is not shown in the exemplary embodiment. In addition, a measuring unit 15 is arranged in the interior space 31 in immediate vicinity of the transmission sleeve 13. The measuring unit 15 detects a measuring signal at a measuring portion 30 of the transmission sleeve 13. With this measuring signal, it is possible to deduce a torque applied on the transmission sleeve 13 and/or a prevailing revolution speed.

A plane 32 borders on a longitudinal end of the measuring portion 30, wherein the longitudinal end faces away from the pinion hub carrier 7. The plane 32 is additionally arranged perpendicular with respect to the axis of rotation 2. The Figures show two additional planes, a first link plane 33 and a second link plane 34. The first link plane 33 is arranged at the longitudinal end of the hub body 3, wherein the longitudinal end of the hub body 3 faces towards the pinion hub carrier 7 and the second link plane 34 is arranged at the longitudinal end of the hub body 3, wherein the longitudinal end of the hub body 3 faces away from the pinion hub carrier 7. In addition, the link planes 33 and 34 are arranged perpendicular with respect to the axis of rotation 2 and centrally between link positions 35 that are intended for spokes at one of the longitudinal ends of the hub body 3.

For sealing of the interior space 31 against external influences, such as for example dirt particles, a first sealing element 18 and a second sealing element 19 are provided in the exemplary embodiment. The first sealing element 18 seals between the hub body 3 and the transmission sleeve 13 and the second sealing element 19 seals between the transmission sleeve 13 and the pinion hub carrier 7.

For the driving of the hub body 3, the torque that is oriented according to a drive direction of rotation acts on a pinion (not shown) that is mounted torsionally rigid on the pinion hub carrier 7. The first freewheel part 10 and the second freewheel part 11 of the drive coupling 26 form a form fit connection, whereby the torque is transmitted from the pinion via the pinion hub carrier 7 and the drive coupling 26 to the transmission sleeve 13. As a result of the transmission sleeve 13 being coupled torsionally rigid with the hub body 3 via the output coupling 14, the measuring portion 30 of the transmission sleeve 12 will be twisted. A magnetization pattern that is arranged on the measuring portion 30 changes depending on the strength of the torsion. This change is detected by the measuring unit 15 and guided outwards along the through opening 23 by the cabling. The transmission of the detected signals can also be, for example, wireless.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 Wheel hub
2 Axis of rotation
3 Hub body
4 First wheel hub bearing
5 Second wheel hub bearing
6 Wheel hub transmission unit
7 Pinion hub carrier
8 First pinion carrier bearing
9 Second pinion carrier bearing
10 First freewheel part
11 Second freewheel part
12 Transmission sleeve bearing
13 Transmission sleeve
14 Output coupling
15 Measuring unit
16 First distance sleeve
17 First axle part
18 First sealing element
19 Second sealing element
20 Second axle part
21 Centering pin
22 Second distance sleeve
23 Through opening
24 First spring part
25 Second spring part
26 Drive coupling
27 First form fit connection
28 Second form fit connection
29 Third form fit connection
30 Measuring portion
31 Interior space
32 Plane
33 First link plane
34 Second link plane
35 Link positions
36 Wheel axle

What is claimed is:

1. A wheel hub transmission unit for a wheel hub of a vehicle, the wheel hub defining an axis of rotation, the wheel hub transmission unit comprising:
a pinion hub carrier arranged concentrically with respect to the axis of rotation and onto which at least one pinion is mounted torsionally rigid to drive the wheel hub;
a hub body arranged axially next to the pinion hub carrier and including an interior space arranged concentrically with respect to the axis of rotation;
the pinion hub carrier having a longitudinal end facing towards the hub body;
a transmission sleeve arranged concentrically with respect to the axis of rotation inside of the interior space, including a magnetically coded material that forms a measuring portion of the transmission sleeve, and having a longitudinal end facing towards the pinion hub carrier;
a drive coupling via which the pinion hub carrier with the longitudinal end of the pinion hub carrier facing towards the hub body and the transmission sleeve with the longitudinal end of the transmission sleeve facing towards the pinion hub carrier are coupled; and
an output coupling via which the transmission sleeve with its other longitudinal end is coupled to the hub body, such that a torque is transmittable from the pinion hub carrier to the hub body via the drive coupling, the output coupling, and the transmission sleeve, such that the torque is detectable in the interior space by the measuring portion of the transmission sleeve by magnetic properties of the magnetically coded material, and
wherein the magnetic properties change under an influence of the torque.

2. The wheel hub transmission unit according to claim 1, wherein:
for coupling the hub body with the transmission sleeve, the output coupling is set at a portion of the longitudinal end of the hub body,
the longitudinal end of the hub body faces away from the pinion hub carrier, and
the portion of the longitudinal end of the hub body is limited in an axial direction towards the pinion hub carrier by a virtual plane that stands perpendicular to the measuring portion and that borders the measuring portion at the longitudinal end that faces away from the pinion hub carrier.

3. The wheel hub transmission unit according to claim 1, wherein:
for coupling the hub body with the transmission sleeve, the output coupling is set at a portion of the longitudinal end of the transmission sleeve,
the longitudinal end of the transmission sleeve faces away from the pinion hub carrier, and
the portion of the longitudinal end of the transmission sleeve extends in an axial direction towards the pinion hub carrier to the measuring portion.

4. The wheel hub transmission unit according to claim 1, wherein:
the transmission sleeve bridges a distance that extends at least from a first link plane defined for spokes to a second link plane defined for the spokes,
the first link plane is defined at one of longitudinal ends of the hub body, and
the second link plane is defined at the other of the longitudinal ends of the hub body.

5. The wheel hub transmission unit according to claim 1, wherein the transmission sleeve is configured such that an axial component of a flow of force is in the same direction along the transmission sleeve.

6. The wheel hub transmission unit according to claim 1, wherein:
the measuring portion is arranged in a portion of the interior space,
the portion of the interior space is limited in an axial direction by two virtual link planes,
the first of the two virtual link planes intersects link positions defined for spokes at one longitudinal end of the hub body, and
the second of the two virtual link planes intersects link positions defined for the spokes at another longitudinal end of the hub body.

7. The wheel hub transmission unit according to claim 1, wherein
the pinion hub carrier and the transmission sleeve are arranged at a distance from one another, and
the drive coupling bridges the distance.

8. A wheel hub transmission unit according to claim 1, wherein the drive coupling is a freewheel.

9. The wheel hub transmission unit according to claim 8, wherein:
the drive coupling includes a first freewheel part connected torsionally rigid with the pinion hub carrier,
the drive coupling includes a second freewheel part connected torsionally rigid with the transmission sleeve, and
the first freewheel part is arranged axially next to the second freewheel part.

10. The wheel hub transmission unit according to claim 9, wherein the first freewheel part and the second freewheel part of the wheel hub transmission unit can be axially displaced.

11. The wheel hub transmission unit according to claim 9, wherein the first freewheel part and the second freewheel part are configured to interact such that the torque is substantially entirely transmittable from the pinion hub carrier to the transmission sleeve only in one direction of rotation of the pinion hub carrier.

12. The wheel hub transmission unit according to claim 1, wherein the transmission sleeve is cantilever mounted.

13. The wheel hub comprising:
the wheel hub transmission unit according to claim 1; and
the at least one pinion being mounted torsionally rigid on the pinion hub carrier, and
wherein for transmitting the torque in only one direction of rotation from a pinion to the hub body, the hub body is coupled torsionally rigid with the pinion via the drive coupling.

14. An auxiliary driven vehicle comprising:
the wheel hub according to claim 13,
a drive assembly with a control device for driving the wheel hub in measured quantities, and
a measuring unit accommodated in the interior space for tapping off the measuring portion of the transmission sleeve, and
the control device being controlled by the measuring unit such that a drive torque of the drive assembly is adapted to the torque transmitted by the wheel hub transmission unit.

15. The auxiliary driven vehicle according to claim 14, wherein the auxiliary driven vehicle is an electric bicycle.
